(19) United States
(12) Patent Application Publication
(10) Pub. No.: US 2004/0173940 A1
(43) Pub. Date: Sep. 9, 2004

(54) Double-face in-mold forming method

(76) Inventors: Yukitomo Yuhara, Tokyo (JP); Mikihiro Kuramitsu, Tokyo (JP)

Correspondence Address: BIRCH STEWART KOLASCH & BIRCH, PO BOX 747, FALLS CHURCH, VA, 22040-0747, US

(21) Appl. No.: 10/485,143

(22) PCT Filed: Aug. 1, 2002
(86) PCT No.: PCT/JP02/07841

(30) Foreign Application Priority Data
Aug. 2, 2001 (JP) 2001-235307
Sep. 11, 2001 (JP) 2001-275483

(51) Int. Cl. B29C 45/14

(52) U.S. Cl. 264/259; 264/328.1

(57) ABSTRACT

One of the object of the invention is to provide a method for manufacturing a double-side in-mold molded product with no need to punch a hole in preventing interfusion of the punch dust into the molded product and formation of a scar on the molded product by the punch dust as well as improving the yield ratio of the molded product.

One representative method for manufacturing a double-side in-mold molded product is a method using a stationary mold 3 and a movable mold 4 having cavities 3b, 4bfor molding a molded product and passing parallel a first continuous film 7 and a second continuous film 14 each having a printing layer 12, 19 facing to one another, including the steps; forming an inlet passage Z extending in a direction intersecting with a film feeding direction for inletting a resin into the cavity 3b, 4bwhen the stationary mold 3 and the movable mold 4 are clamped; forming an inlet V at one end of the inlet passage Z for injecting the resin; placing each edge of the first continuous film 7 and the second continuous film 14 positionally shifted in a direction (direction shown by arrow B) intersecting with the film feeding direction(direction shown by arrow A); and passing through the first continuous film 7 and the second continuous film 14 at the stationary mold side and at the movable mold side, respectively; and further comprising the steps of: pressing the first continuous film 7 and the second continuous film 14 sequentially toward the mold sides by the resin; and injecting the resin between the first continuous film 7 and the second continuous film 14 from the inlet passage after clamping the movable mold 3 and the stationary mold 4 to mold a molded product 21.

### TECHNICAL FIELD

This invention relates to a method for manufacturing a double-side in-mold molded product, in which transfer printings are provided on each side.

### BACKGROUND ART

Conventionally, various methods are provided for manufacturing a transfer molded product in which molding and transfer printing are done simultaneously. Particularly, in a case where the transfer printing is made to the double sides of the molded product, a resin must be injected between two continuous films. One example of this technique for manufacturing such a product having transfer printing on double sides, having a mechanism punching a hole to a film is disclosed in JP-A-62-227613.

In this method for manufacturing a product having transfer printing on double sides, the punching mechanism is provided on a stationary mold side, and the punching mechanism punches a hole to a transfer film provided to the stationary mold side and fed by a positioning means. By injecting the resin through the hole, a product having a various shape with printings transferred at double sides, is obtained.

However, since the method for manufacturing a product having transfer printing on double sides is required to punch the hole in the film, there raises problems that punching dusts may remain in a cavity of the mold during the operation for punching the hole to render the punch dust contained in the transparent molded product, or that a yield of the products may be lowered where the punch dust forms a scar on the surface of the molded product as the punch dusts clung to the mold.

### DISCLOSURE OF THE INVENTION

It is therefore an object of the invention to provide a method for manufacturing double-side in-mold molded product having no need to punch a hole in a film so that a punch dust is prevented to be molded together within the product and that a forming of a scar on the surface of the molded product by the punch dust is prevented, and therefore, the yield of the product is improved.

To solve the above problem, according to the invention, there is provided a representative method for manufacturing double-side in-mold molded product by using a stationary mold and a movable mold having a cavity for molding a molded product and by passing in parallel a first continuous film and a second continuous film each having a printing layer on a surface facing to each other, having the steps of forming an inlet passage for introducing a resin into the cavity when the stationary mold and the movable mold are clamped, the inlet passage formed in a direction intersecting with a film feeding direction, and forming an inlet at one end of the inlet passage for injecting the resin, and placing each edge of the first continuous film and the second continuous film displaced in a direction intersecting with the film feeding direction, and passing the first continuous film and the second continuous film through the stationary mold side and at the movable mold side, respectively; and injecting, to mold a molded product, the resin between the first continuous film and the second continuous film from the inlet passage to press the first continuous film and the second continuous film sequentially toward the mold side after clamping the movable mold and the stationary mold.

### BRIEF DESCRIPTION OF THE DRAWINGS

FIG. 1 is a perspective view of the protective panel formed by a method according to an embodiment of the invention;

FIG. 2 is an explanatory drawing of a step of passing through a continuation film continuously between a stationary mold and a movable mold;

FIG. 3 is an explanatory drawing of the stationary mold and the movable mold;

FIG. 4 is an explanatory drawing of the stationary mold and the movable mold;

FIG. 5 is a drawing showing a sectional side view of a continuous film;

FIG. 6 is a perspective drawing of the continuous film;

FIG. 7 is a perspective drawing of the continuous film;

FIG. 8 is a explanatory drawing of a method for manufacturing a protect panel;

FIG. 9 is an explanatory drawing of the method for manufacturing the protect panel;

FIG. 10 is an explanatory drawing of the method for manufacturing the protect panel;

FIG. 11 is an explanatory drawing of the method for manufacturing the protect panel;

FIG. 12 is an explanatory drawing of the method for manufacturing the protect panel;

FIG. 13 is an explanatory drawing of an arrangement of an inlet passage and a print pattern;

FIG. 14 is an explanatory drawing of a step of passing through a continuation film continuously between a stationary mold and a movable mold of a second embodiment;

FIG. 15 is a sectional view of the stationary mold and the movable mold;

FIG. 16 is a perspective view of the continuous film;

FIG. 17 is an explanatory drawing of a method for manufacturing a protect panel;

FIG. 18 is an explanatory drawing of the method for manufacturing the protect panel;

FIG. 19 is an explanatory drawing of an arrangement of an inlet passage and a print pattern;

FIG. 20 is an explanatory drawing of a stationary mold and a movable mold of a third embodiment;

FIG. 21 is an explanatory drawing of a step of passing through a continuation film continuously between a stationary mold and a movable mold of a forth embodiment;

FIG. 22 is a sectional view of the stationary mold and the movable mold;

FIG. 23 is a perspective view of the continuous film;

FIG. 24 is an explanatory drawing of a method for manufacturing a protect panel; and

FIG. 25 is an explanatory drawing of the method for manufacturing the protect panel.

### BEST MODE FOR CARRYING OUT THE INVENTION

### First Embodiment

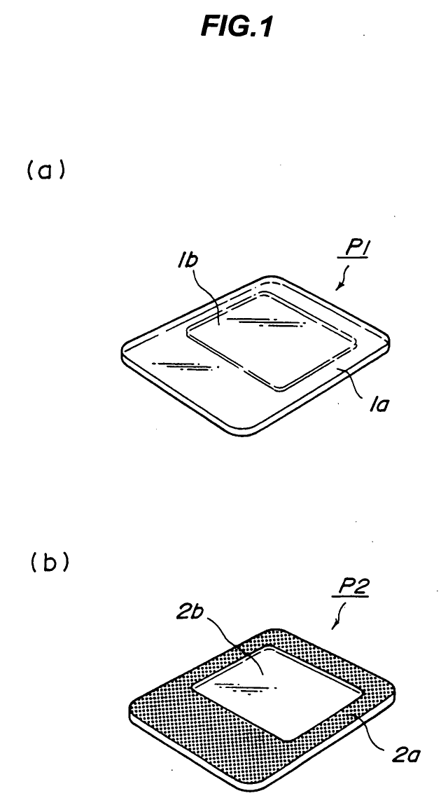

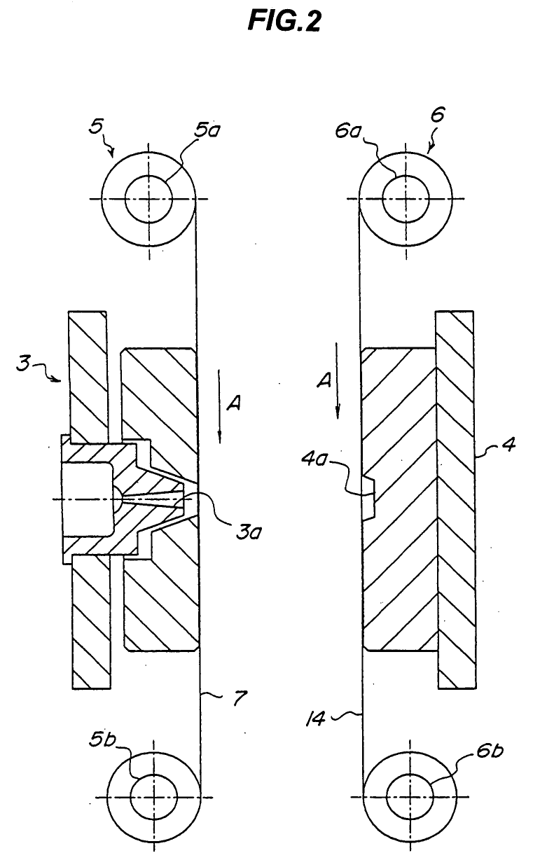

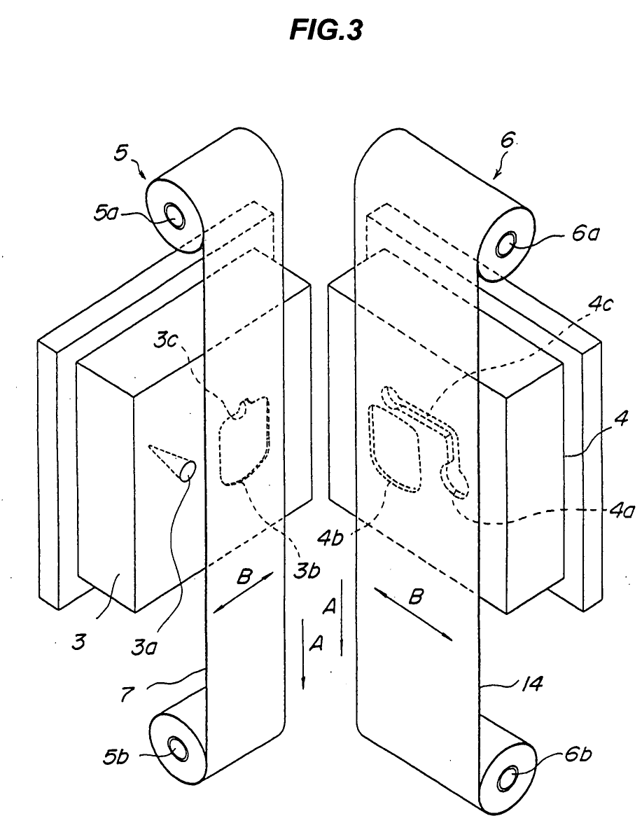

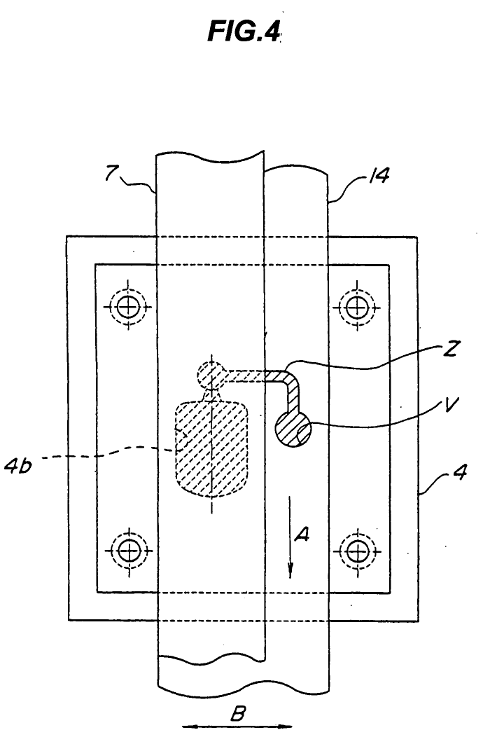

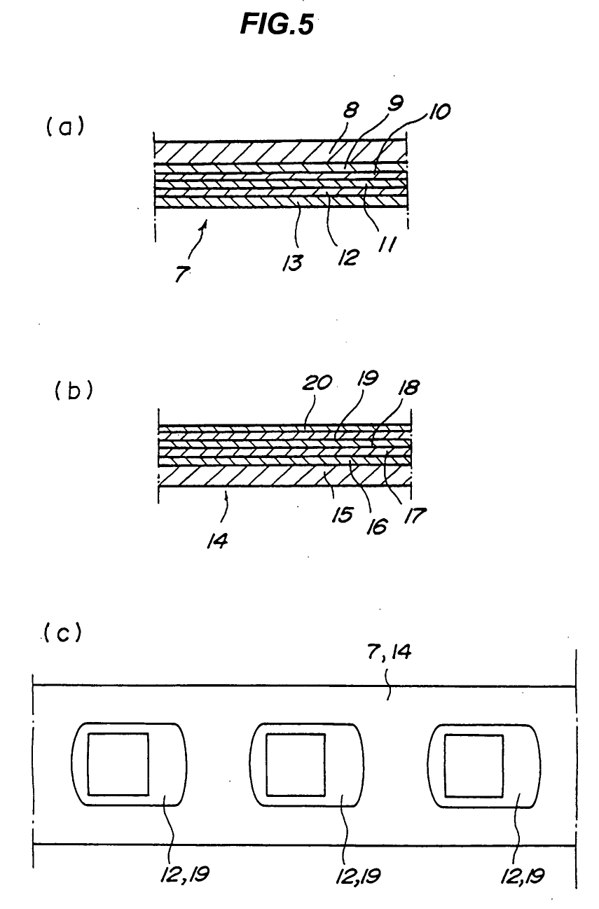

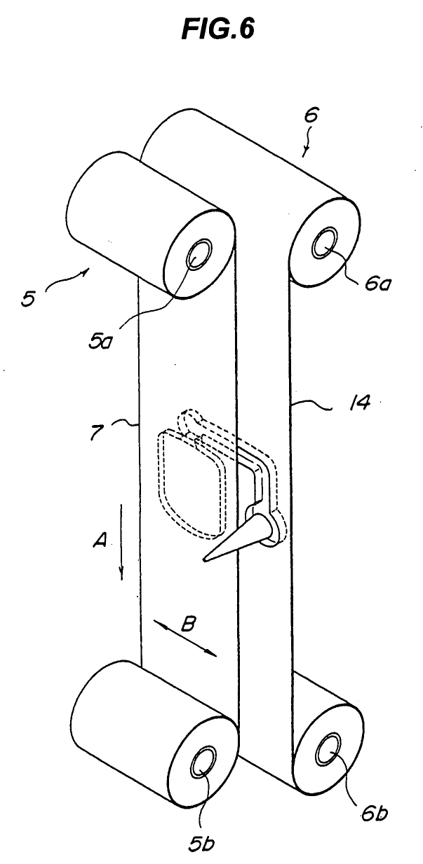

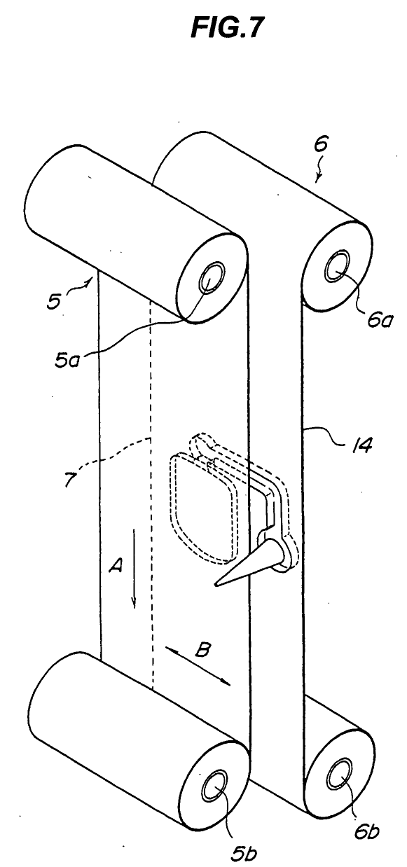

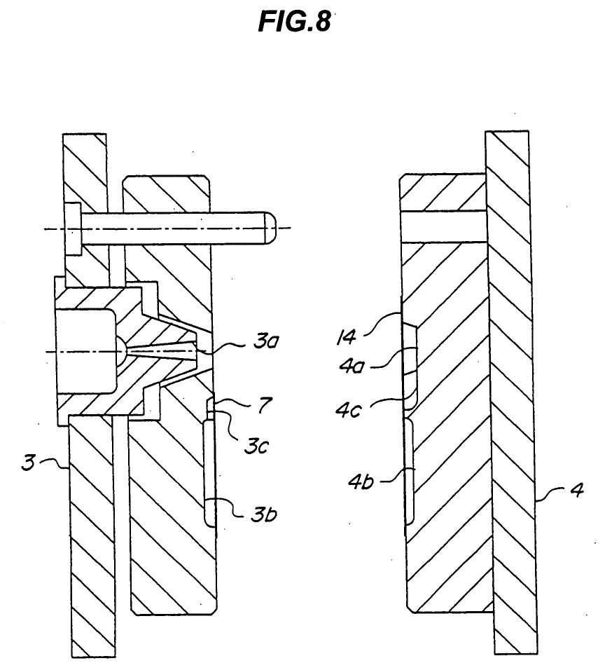

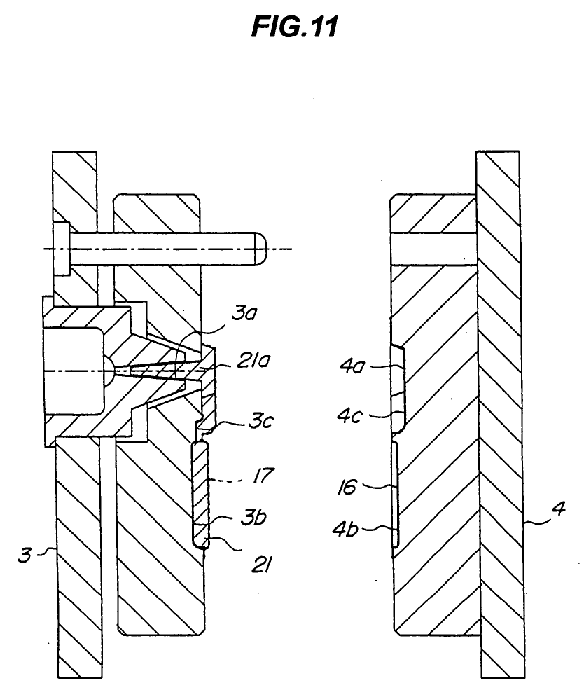

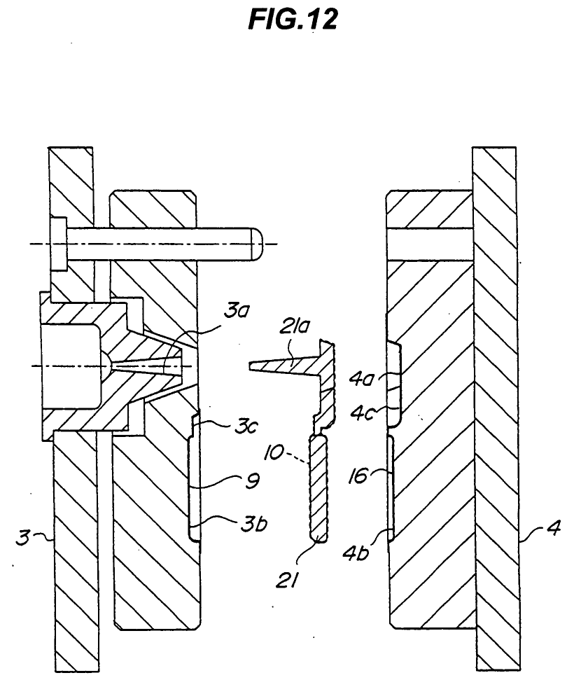

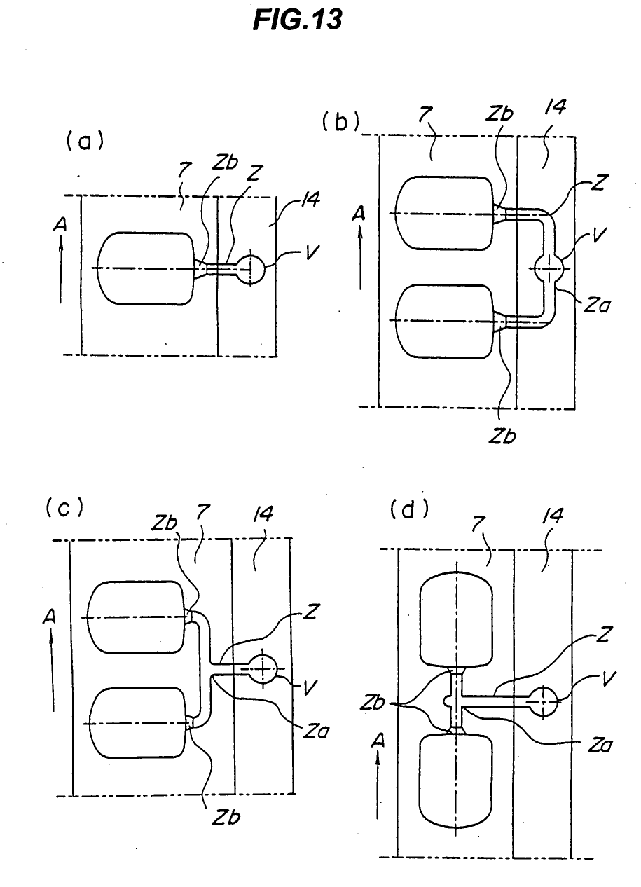

Hereinafter, a first embodiment of the method for manufacturing a double-side in-mold transfer molded product of the invention will be explained referring to the drawings. FIG. 1 is a perspective view of the protective panel formed by a method according to an embodiment of the invention; FIG. 2 is an explanatory drawing of the step a step of passing through a continuation film continuously between a stationary mold and a movable mold; FIGS. 3 and 4 are explanatory drawings of the stationary mold and the movable mold; FIG. 5 is a drawing showing a sectional side view of a continuous film; FIGS. 6 and 7 are perspective drawings of the continuous film; FIGS. 8 through 12 are explanatory drawings of a method for manufacturing a protect panel; and FIG. 13 is an explanatory drawing of an arrangement of an inlet passage and a print pattern.

An example of a protection panel P1 manufactured by the embodiment is shown in FIG. 1. The protection panel P1 is an example of a panel for a display window of an electronic equipment such as a cellular phone. The protection panel P1 is a transparent plate body made of acryl, and as shown in FIG. 1(a), a surface thereof has a translucent frame 1a printed on a surrounding area and a transparent display window 1b through which to display a liquid crystal screen on a central area. Also, as shown in FIG. 1(b), a back side of the protection panel P1 has a metallic frame 2aprinted on a surrounding area and a transparent display window 2bthrough which to display a liquid crystal screen on a central area. As configured above, the protection panel P1 has the transparent display window of the display windows 1a and 1b through which to display the liquid crystal screen on the central area, and the frame with metallic luster formed by the metallic color of the back side seen-through the translucent color of the surface on the surrounding area of the display window.

Hereinafter, a method for manufacturing the protection panel P1 for the display window of an electronic equipment of the embodiment will be explained. The embodiment is an example of a molding apparatus having a method of sending two continuation films parallel.

As shown in FIG. 2, in the first step, a first continuation film 7 and a second continuation film 14 are passed through between a stationary mold 3 and a movable mold 4 continuously.

As shown in FIG. 3, an inlet 3afor introducing a transparent resin, a cavity 3b, and a second curve 3cconnected to the cavity 3bare formed to the stationary mold 3. An inlet 4afor introducing a transparent rein, a first curve 4c, and a cavity 4bare formed to the movable mold 4. As shown in FIG. 4, when the stationary mold 3 and the movable mold 4 are clamped, an inlet passage Z formed by the second curve 3cand the first curve 4cfor introducing the resin into the cavities 3b, 4b, is formed in a direction (direction shown by arrow B in FIG. 3) orthogonal to a film feeding direction (direction shown by arrow A; see FIG. 6). The inlets 3aand 4aare formed in a position where opposing to each other and forming a single inlet V at one end of inlet passage Z when the stationary mold 3 and the movable mold 4 are clamped.

As shown in FIG. 2, a first winding apparatus 5 and a second winding apparatus 6 are attached to the stationary mold 3 and the movable mold 4, respectively. The first winding apparatus 5 and the second winding apparatus 6 have sending rolls 5a, 6aand receiving rolls 5b, 6b, respectively. Continuous films 7, 14 are wound up and hung between the sending roll 5a, 6aand the receiving roll 5b, 6b.

Each of the first continuous film 7 and the second continuous film 14 is wound around sending roll 5a, 6arespectively, and is held. Respective leading ends of the first continuous film 7 and the second continuous film 14 are passed through between the stationary mold 3 and the movable mold 4, and wound up to the receiving rolls 5b, 6bto complete the preparation. As shown in FIG. 6, the first continuous film 7 is configured to be smaller in width than the second continuous film 14.

As shown in FIG. 5(a), the first continuous film 7 is composed of an exfoliation layer 9 made of a material which does not comprise adhesive property, a UV hard layer 10 to improve hardness of the surface, an anchor layer 11 to improve fixing of printing, a printing layer 12, and an adhesive layer 13 layered in sequence on a base film 8 made of polyethylene terephthalate (PET). As shown in FIG. 5(b), the second continuous film 14 is composed of an exfoliation layer 16, a UV hard layer 17, an anchor layer 18, a printing layer 19, and an adhesive layer 20 layered in sequence on a base film 15, in the same manner.

As shown in FIG. 5(c), the printing layers 12, 19 have an area where printings are formed (frames 1a, 2a) and an area where printings are not formed (display windows 1b, 2b). The transparent display window (see FIG. 1) is formed by disposing the transparent resin layer through the area where printings are not formed. Plural discrete printing patterns are formed on the printing layers 12, 19 at specified intervals.

As shown in FIG. 6, by configuring the first continuous film 7 and the second continuous film 14 to have different width, only the second continuous film 14 is placed to be opposed to the inlet 4a. Namely, the first continuous film 7 is placed solely at the stationary mold side to be opposed to the cavity 3b, and the second continuous film 14 is placed solely at the movable mold side to be opposed to the inlet 4a, the cavity 4b, and the first curve 4c. In a situation when the first and second winding apparatus 5, 6 are started, the second continuous film 14 is intermittently fed between the stationary mold 3 and the movable mold 4 in parallel with the feeding direction (direction shown by arrow A) of the first continuous film 7 in a status where each of the adhesive layers 13, 20 faces to each other. The intermittent feeding operation is controlled so that the printing pattern consistently corresponds to the cavity 3bof the stationary mold 3 and the cavity 4bof the movable mold 4.

As shown in FIG. 6, the two continuous films are configured to have different width so that only the second continuous film 14 is placed to be opposed to the inlet 4a. However, as shown in FIG. 7, in case when the first continuous film 7 and the second continuous film 14 are having same width, it is possible to configure placing only the second continuous film 14 to be opposed to the inlet 4a, by feeding the first continuous film 7 at the stationary mold side in a manner to be opposed to the cavity 3b, and by shifting the second continuous film 14 in width direction (direction shown by arrow B) and feeding at the movable mold side in a manner to be opposed to the inlet 4a, the cavity 4b, and the first curve 4c.

Next, a resin injection step will be explained referring to FIGS. 8 through 12. As shown in FIG. 8, after the printing patterns of the first continuous film 7 and the second continuous film 14 are stopped at respective positions within the cavities 3b, 4bas described above, the stationary mold 3 and the movable mold 4 are clamped.

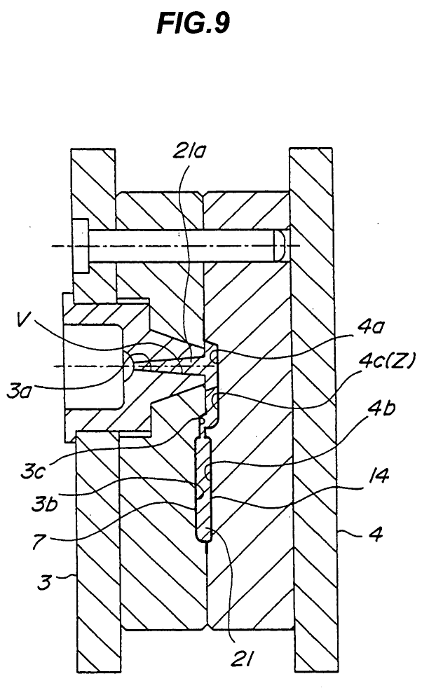

As shown in FIG. 9, after clamping the stationary mold 3 and the movable mold 4, the transparent resin is injected through the inlet V. The injected transparent resin proceeds through the first curve 4cby pressing the second continuous film 14 toward the movable mold 4, and proceeds through the second curve 3cby pressing the first continuous film 7 towards the stationary mold 3, and fill in the inlet passage Z. The transparent resin is filled within the cavities 3b, 4bby pressing the first continuous film 7 and the second continuous film 14 toward the stationary mold side and the movable mold side, and become united with the first continuous film 7 and the second continuous film 14 to mold a molded product 21.

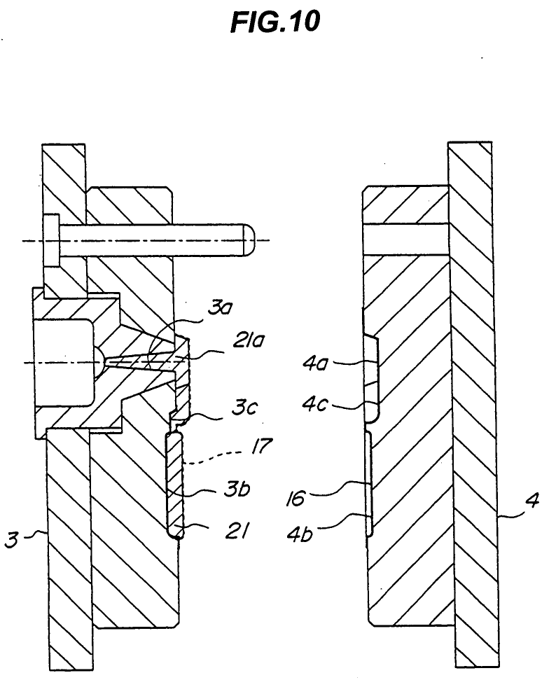

After the molded product 21 is hardened, as shown in FIGS. 10 through 12, the stationary mold 3 and the movable mold 4 are opened, the molded product 21 is pressed out in a manner that the molded product 21 is left stick to the stationary mold side by the adhesive force between the inlet 3aand a sprue formation portion 21aformed at the inlet 3aafter the injection, and the molded product 21 is detached by vacuum detacher (not shown). Herewith, the molded product 21 is detached from the first continuous film 7 and the second continuous film 14 between the exfoliation layers 9, 16 and the UV hard layers 10, 17.

Then, the sprue formation portion 21a, which is a portion formed within the inlet, is cut off, and the manufacturing of the protection panel P1 is accomplished.

As described above, by passing through the first continuous film 7 and the second continuous film 14 in a manner that the second continuous film 7 only opposes to the inlet 4a, and after clamping the movable mold 4 and the stationary mold 3, injecting the transparent resin in between the first continuous film 7 and the second continuous film 14 through the inlet passage Z, thereby forming the molded product 21, an inflow of the transparent resin between the continuous film and the mold can be prevented. Furthermore, in the above-described method, there is no need to punch a hole. Therefore, an interfusion of the punch dust produced when punching a hole into the molded product 21 and the forming of a scar on the molded product 21 by the punch dust can be prevented, and the yield ratio of the molded product 21 .can be improved.

In addition, the inlet passage Z can be formed in a direction intersecting to the film feeding direction (direction shown by arrow A; see FIG. 6) and as a passage connects to the outside of the first continuous film, and is not limited to the forming of the embodiment. For example, as shown in FIG. 13(a), when the printing pattern is placed intersecting with the film feeding direction (direction shown by arrow A), the inlet passage Z can be formed straight.

In addition, as shown in FIG. 13(b), two printing patterns can be placed parallel in a direction intersecting with the film feeding direction (direction shown by arrow A). In this modification, the inlet passage Z is formed so as to be connected to each of the two printing patterns, and a diverging point Za of the inlet passage Z is formed at outside of the first continuous film 7 (in common with the inlet V).

In addition, as shown in FIG. 13(c), two printing patterns can be placed parallel in a direction intersecting with the film feeding direction (direction shown by arrow A). In this modification, the branching-off point Za of the inlet passage Z is formed within the area of the first continuous film 7.

In addition, as shown in FIG. 13(d), two printing patterns can be placed parallel in a direction intersecting with the film feeding direction (direction shown by arrow A) and to be opposed to the branching-off point Za of the inlet passage Z. In this modification, the inlet passage Z is formed so as to be connected to each of the two printing patterns, and the branching-off point Za is formed within the area of the first continuous film 7 and between the two printing patterns.

### Second Embodiment

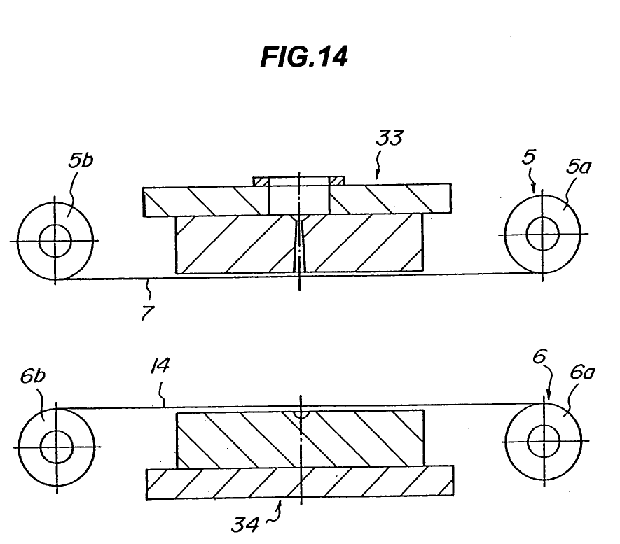

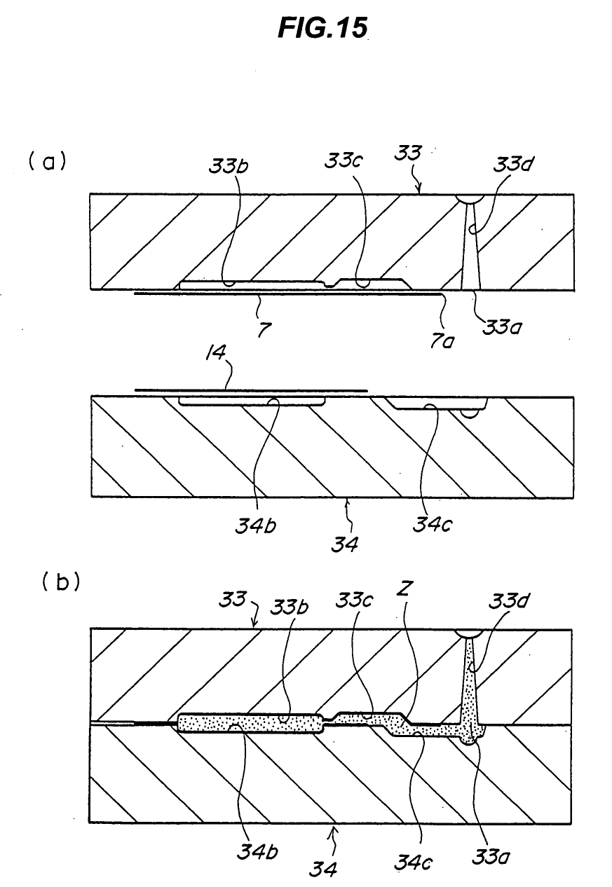

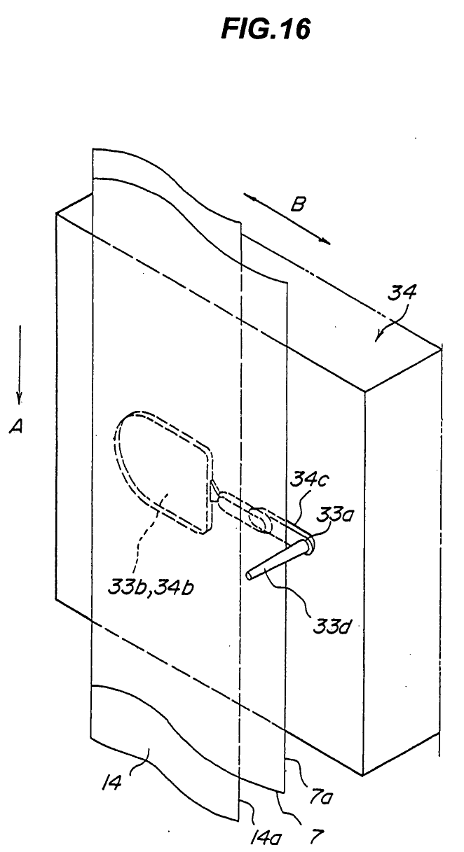

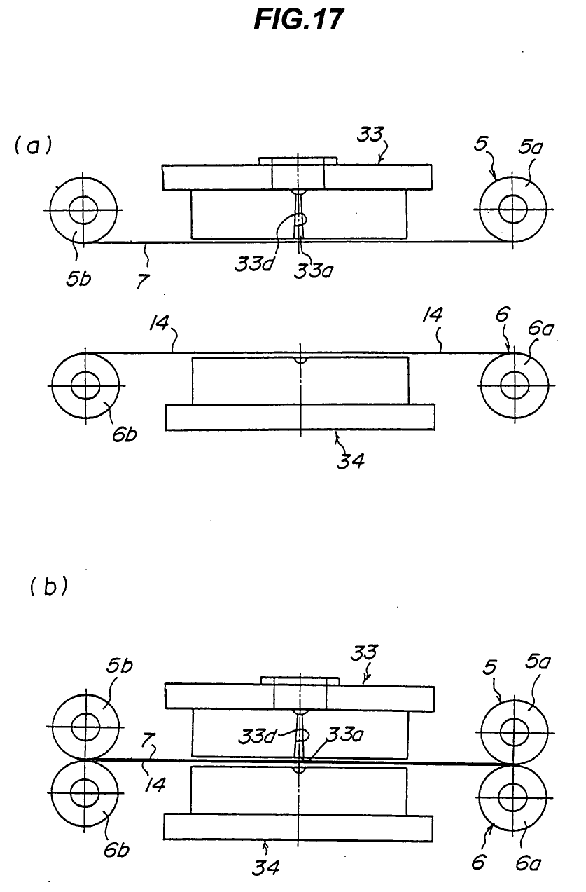

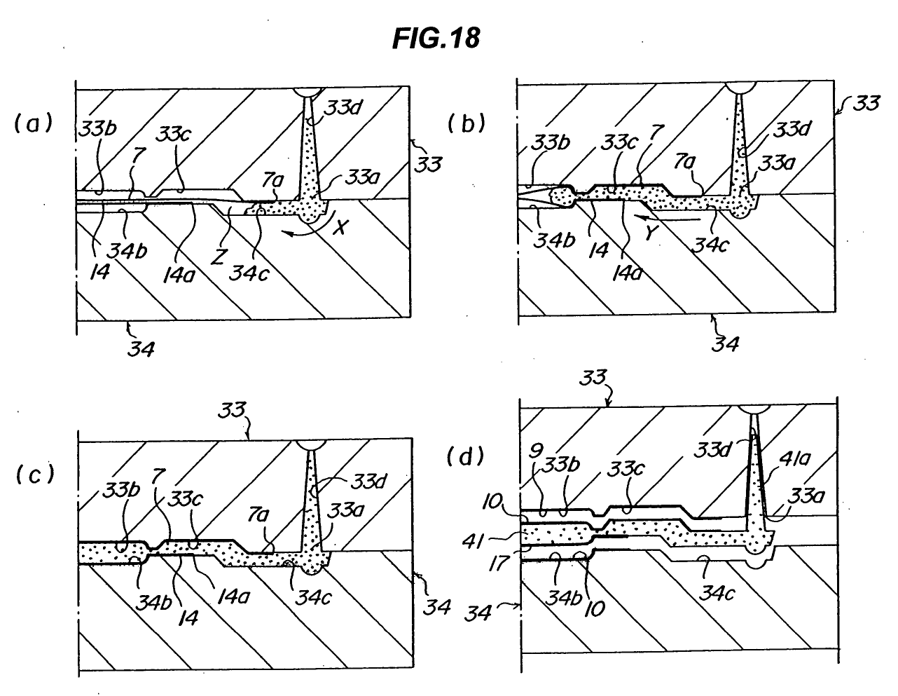

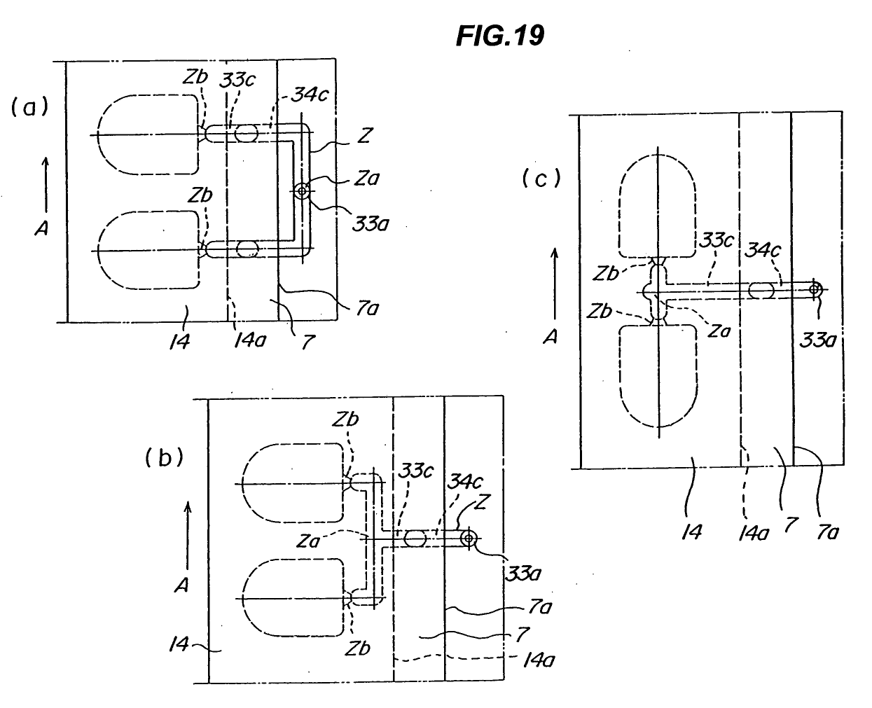

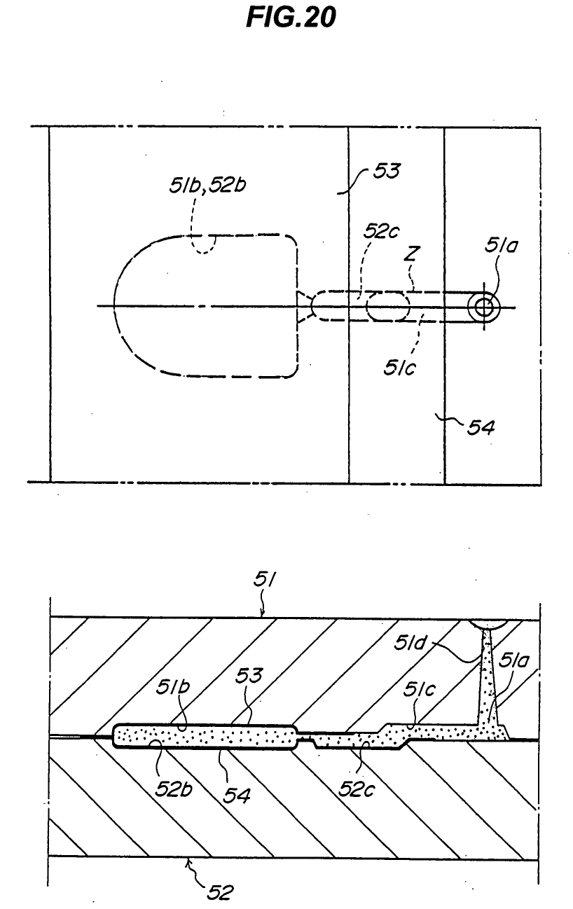

Hereinafter, a second embodiment of the method for manufacturing a double-side in-mold molded product of the invention will be explained referring to the drawings. FIG. 14 is an explanatory drawing of a step of passing through a continuation film continuously between a stationary mold and a movable mold of a second embodiment; FIG. 15 is a sectional view of the stationary mold and the movable mold; FIG. 16 is a perspective view of the continuous film; FIGS. 17 and 18 are explanatory drawings of a method for manufacturing a protect panel; FIG. 19 is an explanatory drawing of an arrangement of an inlet passage and a print pattern; and FIG. 20 is an explanatory drawing of a stationary mold and a movable mold of a another embodiment. Hereinafter, the portions redundant to the above-described first embodiment will be referred same reference numbers and the explanation thereof will be abbreviated.

An example of method for manufacturing the protection panel P1 according to the embodiment will be described hereinafter. The embodiment is an example of a molding apparatus having a method of sending two continuation films parallel.

As shown in FIG. 14, in the first step, a first continuation film 7 and a second continuation film 14 is passed through between a stationary mold 33 and a movable mold 34 continuously.

As shown in FIG. 15(a), a sprue 33dfor inletting a transparent resin from an inlet 33c, a second curve 33c,and a cavity 33bare formed to the stationary mold 33. A first curve 34cand a cavity 34bare formed to the movable mold 34. As shown in FIG. 15(b), when the stationary mold 3 and the movable mold 4 are clamped, in the order from a side of the inlet 33aof sprue 33d, the first curve 34cand the second curve 33cforms an S-shaped inlet passage Z extending in a direction (direction shown by arrow B, see FIG. 16) orthogonal to the film feeding direction (direction shown by arrow A; see FIG. 16). The sprue 33dand the inlet 33aare formed in a position where opposing to the first curve 34cwhen the stationary mold 3 and the movable mold 4 are clamped.

As shown in FIG. 14, a first winding apparatus 5 and a second winding apparatus 6 are attached to the stationary mold 33 and the movable mold 34, respectively. Each of the first winding apparatus 5 and the second winding apparatus 6 has the respective pair of the sending rolls 5a, 6aand receiving rolls 5b, 6b. Continuous films 7, 14 are wound up and hung between the sending roll 5a, 6aand the receiving roll 5b, 6b.

The first continuous film 7 and the second continuous film 14 are wound and held respectively around the sending rolls 5a, 6a. Leading ends of the first continuous film 7 and the second continuous film 14 are passed through between the stationary mold 33 and the movable mold 34 and wound up to the receiving rolls 5b, 6b, to complete the preparation. As shown in FIG. 16, the first continuous film 7 is configured to be wider in width than the second continuous film 14.

As shown in FIG. 16, by configuring the first continuous film 7 and the second continuous film 14 to have different widths, the first continuous film 7 is placed at the movable mold side to be opposed to the first curve 34c, and the second continuous film 14 is placed at the stationary mold side to be opposed to the second curve 33c. Upon starting operation of the first and second winding apparatus 5, 6, the second continuous film 14 is intermittently fed between the stationary mold 33 and the movable mold 34 in parallel with the feeding direction (direction shown by arrow A) of the first continuous film 7 as each of the adhesive layers 13, 20 faces to each other. The intermittent feeding operation is controlled so that the printing pattern consistently corresponds to the cavity 33bof the stationary mold 33 and the cavity 34bof the movable mold 34.

Next, a resin injection molding step will be explained referring to FIGS. 17 and 18. As shown in FIG. 17(a), after the printing patterns of the first continuous film 7 and the second continuous film 14 are stopped in respective positions within the cavities 33b, 34bas described above, the stationary mold 33 and the movable mold 34 are clamped as shown in FIG. 17(b).

As shown in FIG. 18(a), after clamping the stationary mold 33 and the movable mold 34, the transparent resin is injected from the sprue 33dthrough the inlet 33a. When the transparent resin thus injected passes through the first curve 34c, the force of the flowing resin does not exert against an edge portion 7aof the first continuous film 7 opposed to the first curve 34c. That is, the transparent resin injected from the inlet 33aenters in the first curve 34c, and its heading direction X becomes a direction toward the movable mold 34, and the resin moves to the lower area of the edge. portion 7aof the first continuous film 7 existing at the stationary mold 33 side. Therefore, the injected transparent resin does not flow inside the first continuous film 7, and the first continuous film 7 can be assuredly pressed toward the cavity 33b.

As shown in FIG. 18(b), the transparent resin filled in the first curve 34cproceeds through the second curve 33c, and at that time, the force of the flowing resin does not exert against an edge portion 14aof the second continuous film 14 opposed to the second curve 33c. That is, the transparent resin filled in the first curve 34centers in the second curve 33c, and its heading direction Y becomes a direction toward the stationary mold 33, and the resin moves over the edge portion 14aof the second continuous film 14 existing at the movable mold 34 side. Therefore, the injected transparent resin does not flow inside the second continuous film 14, and the second continuous film 14 can be assuredly pressed toward the cavity 34b.

As shown in FIG. 18(c), the transparent resin filled in the second curve 33cis loaded in the cavities 33b, 34bas pressing the first continuous film 7 and the second continuous film 14 toward the stationary mold side and the movable mold side, respectively, to mold a molded product 41 in which the first continuous film 7 and the second continuous film 14 are united.

After the molded product 41 becomes hard as shown in FIG. 18(d), the stationary mold 33 and the movable mold 34 are opened, the molded product 21 is pushed out in a manner that the molded product 21 is left stick to the stationary mold side by the adhesive force to a sprue formation portion 41aformed at the sprue 33d, and the molded product 41 is detached by vacuum detacher (not shown). Herewith, the molded product 41 is detached from the first continuous film 7 and the second continuous film 14 between the exfoliation layers 9, 16 and the UV hard layers 10, 17.

Then, the sprue formation portion 41a, serving as a portion formed within the sprue 33d, is trimmed to form the protection panel P1.

As described above, by passing through the first continuous film 7 at the stationary mold 33 side in a manner to be opposed to the first curve 34c, and by passing through the second continuous film 14 at the movable mold 34 side in a manner to be opposed to the second curve 33c, after clamping the movable mold 34 and the stationary mold 33, the molded product 41 is molded by injecting the transparent resin between the first continuous film 7 and the second continuous film 14 through the S-shaped inlet passage Z upon clamping the movable mold 34 and the stationary mold 33 with each other, thereby preventing an inflow of the transparent resin between the continuous film and the mold. Furthermore, in the above-described method with not punching a hole, an interfusion of the punch dust produced when punching a hole into the molded product 41 and the forming of a scar on the molded product 41 by the punch dust can be prevented, and the yield ratio of the molded product 41 can be improved.

In addition, the inlet passage Z can be extended in a direction intersecting with the film feeding direction (direction shown by arrow A; see FIG. 16) as well as connecting to the exterior of the first continuous film, and is not limited to the shape of the embodiment. For example, as shown in FIG. 19(a), the two printing patterns are placed in row in a direction intersecting to the film feeding direction (direction shown by arrow A) as coupled to the sole inlet passage Z, thereby forming a branching off point Za of the inlet passage Z at the exterior of the first continuous film 7 (commonly formed with the inlet 33a).

In addition, as shown in FIG. 19(b), the two printing patterns are placed in row in a direction intersecting to the film feeding direction (direction shown by arrow A) as coupled to the sole inlet passage Z, thereby forming a branching off point Za of the inlet passage Z within a region of the second continuous film 14.

In addition, as shown in FIG. 19(c), two printing patterns can be placed in row in a direction intersecting to the film feeding direction (direction shown by arrow A) and to be opposed to the branching off point Za of the inlet passage Z so that the sole inlet passage Z connects to each of the two printing patterns, and the branching-off point Za is formed within the area of the second continuous film 14 and between the two printing patterns.

### Third Embodiment

Hereinafter, a third embodiment of the method for manufacturing a double-side in-mold molded product of the invention will be explained referring to the drawings. FIG. 20 is an explanatory drawing of a stationary mold and a movable mold of a third embodiment. Hereinafter, the portions redundant to the above-described first embodiment will be referred same reference numbers and the explanation thereof will be abbreviated.

In the embodiment, in lieu of the stationary mold 33 and the movable mold 34 of the above-described second embodiment, a stationary mold 51 and a movable mold 52 are used as shown in FIG. 20.

A sprue 51d for introducing a transparent resin from an inlet 51a, a first curve 51c connected to the sprue 51d, and a cavity 51d are formed to the stationary mold 51. A second curve 52c, and a cavity 52bconnected to the second curve 52care formed to the movable mold 52. As shown in FIG. 20, when the stationary mold 51 and the movable mold 52 are clamped, an S-shaped inlet passage Z is formed as extending in direction orthogonal to the film feeding direction (direction shown by arrow A; see FIG. 16) by the first curve 51c and the second curve 52cin the order from a side of the inlet 51a of sprue 51d. In addition, by configuring a first continuous film 53 and a second continuous film 54 to have different widths, the first continuous film 53 is placed at the movable mold side to be opposed to the second curve 52c, and the second continuous film 54 is placed at the stationary mold side to be opposed to the first curve 51c.

By using the above configured stationary mold 51 and the movable mold 52, where passing through the first continuous film 53 at the stationary mold 51 side in a manner to be opposed to the second curve 52cas well as passing through the second continuous film 54 at the movable mold side 52 in a manner to be opposed to the first curve 51c, a molded product 41 is molded by injecting the transparent resin between the first continuous film 53 and the second continuous film 54 through the S-shaped inlet passage Z after clamping the movable mold 52 and the stationary mold 51, thereby preventing an inflow of the transparent resin between the continuous film. Furthermore, in the above-described method without punching any hole, an interfusion of the punch dust produced when punching a hole into the molded product 41 and the forming of a scar on the molded product 41 by the punch dust can be prevented, and the yield ratio of the molded product 41 can be improved.

In addition, in the embodiment, the second continuous film 54 is passed through at the side of the movable mold 52, which the inlet 51a is not formed, so that the second continuous film 54 can be passed through at a position opposed to the inlet 51a. Therefore, by the configuration of the embodiment, the inflow of the transparent resin between the second continuous film 54 and the movable mold 52 can be assuredly prevented.

### Fourth Embodiment

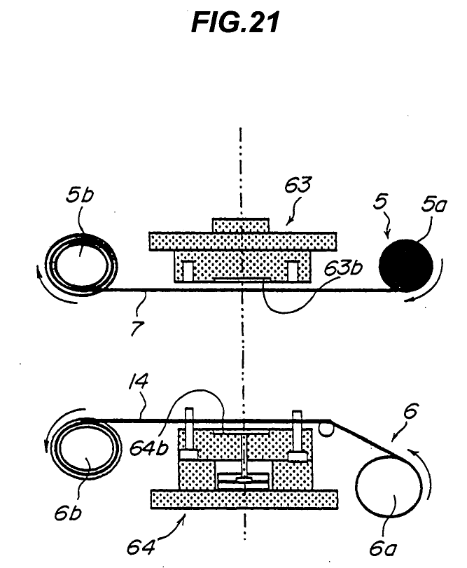

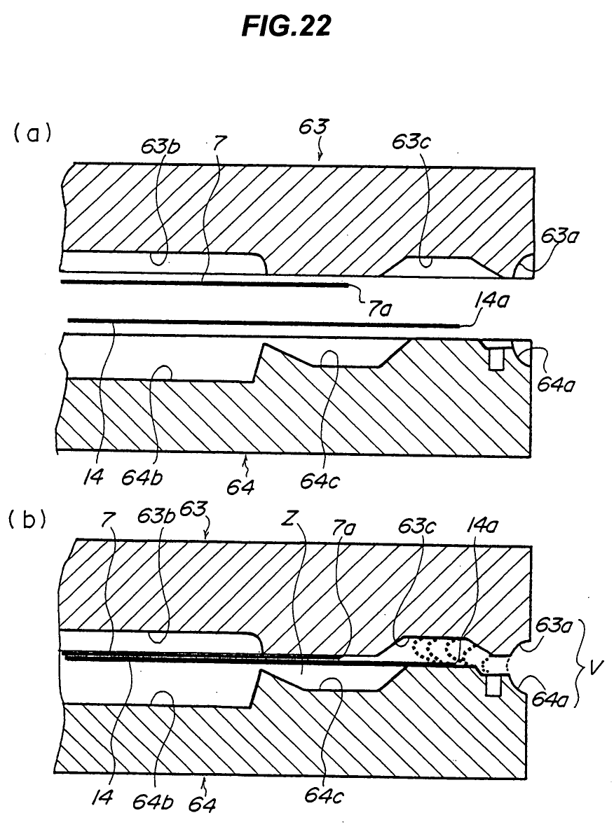

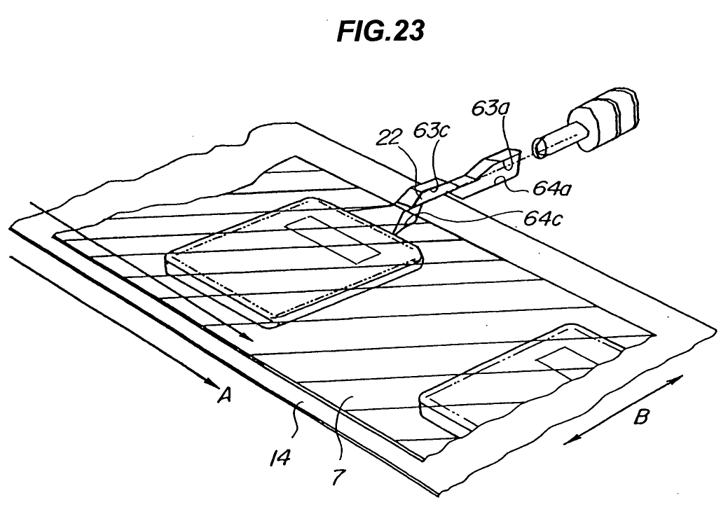

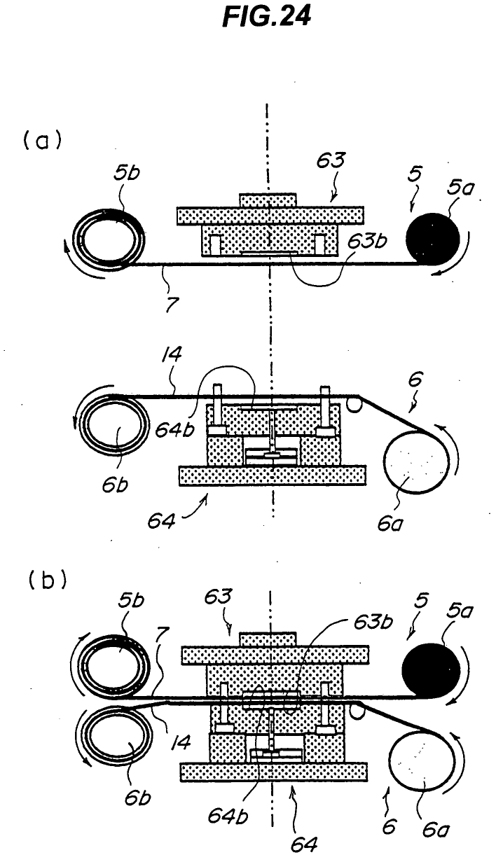

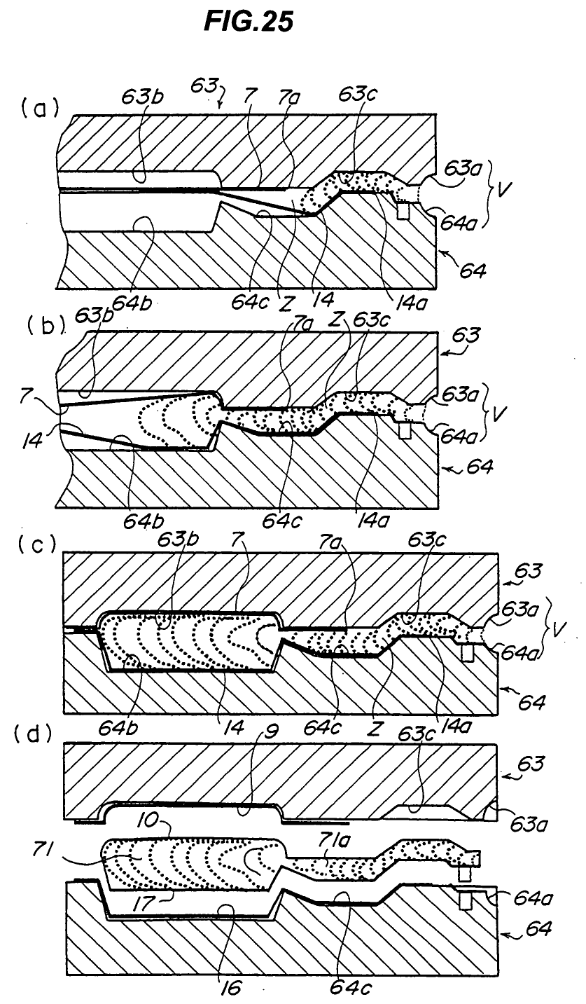

Hereinafter, a fourth embodiment of the method for manufacturing a double-side in-mold molded product of the invention will be explained referring to the drawings. FIG. 21 is an explanatory drawing of a step of passing through a continuation film continuously between a stationary mold and a movable mold of a forth embodiment; FIG. 22 is a sectional view of the stationary mold and the movable mold; FIG. 23 is a perspective view of the continuous film; and FIGS. 24 and 25 are explanatory drawings of a method for manufacturing a protect panel. Hereinafter, the portions redundant to the above-described first embodiment will be referred same reference numbers and the explanation thereof will be abbreviated.

An example of method for manufacturing the protection panel P1 according to the embodiment will be described hereinafter. The embodiment is an example of a molding apparatus having a method of sending two continuation films parallel.

As shown in FIG. 21, in the first step, a first continuation film 7 and a second continuation film 14 are passed through between a stationary mold 63 and a movable mold 64 continuously.

As shown in FIG. 22(a), an inlet 63dfor inletting a transparent resin, a first curve 63c,and a cavity 63bare formed to the stationary mold 63. An inlet 64a, a second curve 64c, and a cavity 64bconnected to the second curve 64care formed to the movable mold 64. As shown in FIG. 22(b), when the movable mold 64 and the stationary mold 63 are clamped, an S-shaped inlet passage Z is formed of the first curve 63cand the second curve 64cin extending in a direction orthogonal to the film feeding direction (direction shown by arrow A; see FIG. 23) from a side of the inlet 63asequentially. The inlets 63a, 64aare formed in a position where opposing each other and forming a single inlet when the stationary mold 63 and the movable mold 64 are clamped.

As shown in FIG. 21, a first winding apparatus 5 and a second winding apparatus 6 are attached to the stationary mold 63 and the movable mold 64, respectively. Each of the first winding apparatus 5 and the second winding apparatus 6 has respective pair of sending rolls 5a, 6aand receiving rolls 5b, 6b. Continuous films 7, 14 are wound up and hung between the sending rolls 5a, 6aand the receiving rolls 5b, 6b.

Each of the first continuous film 7 and the second continuous film 14 is wound around the sending roll 5a, 6arespectively, and is held. Leading ends of the first continuous film 7 and the second continuous film 14 are passed through between the stationary mold 63 and the movable mold 64 and wound up to the receiving rolls 5b, 6bto complete the preparation. As shown in FIG. 23, the first continuous film 7 is configured to be narrower in width than the second continuous film 14.

As shown in FIG. 23, by configuring the first continuous film 7 and the second continuous film 14 to have different widths, the first continuous film 7 is placed at the stationary mold side to be opposed to the second curve 64c, and the second continuous film 14 is placed at the movable mold side to be opposed to the first curve 64c. In a status when the first and second winding apparatus 5, 6 are started, the second continuous film 14 is intermittently fed between the stationary mold 63 and the movable mold 64 in parallel with the feeding direction (direction shown by arrow A) of the first continuous film 7 where each of the adhesive layers 13, 20 faces each other. The intermittent feeding operation is controlled so that the printing pattern consistently corresponds to the cavity 63bof the stationary mold 63 and the cavity 64bof the movable mold 64.

Next, a resin injection molding step will be explained referring to FIGS. 24 and 25. As shown in FIG. 24(a), after the printing patterns of the first continuous film 7 and the second continuous film 14 are stopped in positions within the cavities 63b, 64bas described above, and the stationary mold 63 and the movable mold 64 are then clamped as shown in FIG. 24(b).

As shown in FIG. 25(a), after clamping the stationary mold 63 and the movable mold 64, the transparent resin is injected from the inlet V. When the injected transparent resin passes through the first curve 63c, the force of the flowing resin does not exert to an edge portion 14aof the second continuous film 14 opposed to the first curve 63c. That is, the transparent resin injected from the inlet V enters in the first curve 63c, and its heading direction X becomes a direction toward the stationary mold 63, thereby rendering the resin move over the edge portion 14aof the second continuous film 14 existing at the movable mold 64 side. Therefore, the injected transparent resin does not inflow inside the second continuous film 14, and the second continuous film 14 can be assuredly pressed toward the cavity 64b.

As shown in FIG. 25(b), the transparent resin filled in the first curve 34cproceeds to the second curve 64c, and at that time, the force of the flowing resin does not exert against an edge portion 7aof the first continuous film 7 opposed to the second curve 64c. That is, the transparent resin moves into the second curve 64cafter it fills in the first curve 63c, and its heading direction Y becomes a direction toward the movable mold 64, thereby rendering the resin move under the edge portion 7aof the first continuous film 7 existing at the stationary mold 63 side. Therefore, the injected transparent resin does not inflow inside the first continuous film 7, and the first continuous film 7 can be assuredly pressed towards the cavity 63b.

As shown in FIG. 25(c), the transparent resin filling in the second curve 64cis further filled in the cavities 63b, 64bby pressing the first continuous film 7 and the second continuous film 14 toward the stationary mold side and the movable mold side, respectively, and becomes united with the first continuous film 7 and the second continuous film 1 to mold a molded product 71.

After the molded product 71 becomes hard, as shown in FIG. 25(d), the stationary mold 63 and the movable mold 64 are opened, and the molded product 71 is detached by vacuum detacher (not shown). Herewith, the molded product 71 is detached from the first continuous film 7 and the second continuous film 14 between the exfoliation layers 9, 16 and the UV hard layers 10, 17.

Then, the sprue formation portion 71a, a formed portion remaining in the inlet, is cut off, and thereby the protection panel P1 is molded.

As described above, by passing through the first continuous film 7 at the stationary mold 63 side in a manner to be opposed to the second curve 64c, and by passing through the second continuous film 14 at the movable mold 64 side in a manner to be opposed to the first curve 63c, and after clamping the movable mold 64 and the stationary mold 63, a molded product 71 is molded by injecting the transparent resin in between the first continuous film 7 and the second continuous film 14 through the S-shaped inlet passage Z, and an inflow of the transparent resin between the continuous film and the mold can be prevented. Furthermore, in the above-described method without punching any hole, an interfusion of the punch dust produced when punching a hole into the molded product 71 and the forming of a scar on the molded product 71 by the punch dust can be prevented, and the yield ratio of the molded product 71 can be improved.

In addition, the inlet passage Z can be formed in a direction intersecting with the film feeding direction (direction shown by arrow A; see FIG. 16) and as a passage connecting to the exterior of the continuous film, and is not limited to the configuration of the embodiment that to be formed in direction orthogonal to the film feeding direction.

Industrial Applicability

As described above, forming an inlet passage extending in a direction orthogonal to a film feeding direction for inletting the resin into the cavity when clamping the stationary mold and the movable mold, forming an inlet at one end of the inlet passage for injecting the resin; placing each edge of the first continuous film and the second continuous film positionally shifted in a direction orthogonal to the film feeding direction; the first continuous film and the second continuous film are passed through at the stationary mold side and at the movable mold side, respectively. A molded product is molded by injecting the resin between the first continuous film and the second continuous film from the inlet passage after clamping the movable mold and the stationary mold and pressing the first continuous film and the second continuous film sequentially toward the mold side by the resin. Hence, by applying the method with no need to punch a hole, an interfusion of the punch dust into the molded product and the forming of a scar on the molded product by the punch dust can be prevented, and the yield ratio of the molded product can be improved

1. A method for double-side in-mold transfer molding in using a stationary mold and a movable mold having a cavity for molding a molded product and passing a first continuous film and a second continuous film each having a printing layer facing to one another, the method comprising steps of:
forming an inlet passage extending in a direction orthogonal to a film feeding direction for inletting a resin into the cavity when the stationary mold and the movable mold are clamped;
forming an inlet at one end of the inlet passage for injecting the resin;
placing each edge of the first continuous film and the second continuous film positionally shifted in a direction orthogonal to the film feeding direction; and
passing through the first continuous film and the second continuous film at the stationary mold side and at the movable mold side, respectively;
and further comprising the steps of:
pressing the first continuous film and the second continuous film sequentially toward the mold sides by the resin; and
injecting the resin between the first continuous film and the second continuous film from the inlet passage after clamping the movable mold and the stationary mold to mold a molded product.

2. A method for double-side in-mold transfer molding in using a stationary mold and a movable mold having a cavity for molding a molded product and passing a first continuous film and a second continuous film each having a printing layer facing to one another, the method comprising steps of:
forming an inlet passage extending in a direction orthogonal to a film feeding direction for inletting a resin into the cavity when the stationary mold and the movable mold are clamped;
forming an inlet at one end of the inlet passage for injecting the resin; and
passing through the first continuous film at the stationary mold side and through the second continuous film at the movable mold side in a manner such that only the second continuous film opposes to the inlet;
and comprising the step of injecting the resin between the first continuous film and the second continuous film from the inlet passage after clamping the movable mold and the stationary mold to mold a molded product.

3. The method for double-side in-mold transfer molding as claimed in claim 2, wherein the inlet passage is formed by a first curve formed at the movable mold side in a cross-sectional direction and a second curve formed at the stationary mold side in the cross-sectional direction, and wherein the inlet is connected to the first curve.

4. A method for double-side in-mold transfer molding in using a stationary mold and a movable mold having a cavity for molding a molded product and passing parallel a first continuous film and a second continuous film each having a printing layer facing to one another, the method comprising the steps of:
rendering the stationary mold and the movable mold have a first curve and a second curve, respectively;
forming, on a side of the stationary mold out of a passing range of the first and second continuous films, an S-shaped inlet passage extending in a direction intersecting with a film feeding direction having the first curve and the second curve sequentially in the order from a side of an inlet of a sprue so opened as to face to the movable mold side when the molds are clamped;
passing through the first continuous film on the side of the stationary mold as to render an end thereof face to the curve of the movable mold; and
passing through the second continuous film on the side of the movable mold as to render an end thereof face to the curve of the stationary mold
and further comprising the step of:
injecting a resin between the first continuous film and the second continuous film from the S-shaped inlet passage upon clamping the movable mold and the stationary mold to mold a molded product.

5. A method for double-side in-mold transfer molding in using a stationary mold and a movable mold having a cavity for molding a molded product and passing parallel a first continuous film and a second continuous film each having a printing layer facing to one another, the method comprising the steps of:
rendering the stationary mold have a second curve coupled to the cavity;
rendering the movable mold have a first curve opposed to a sprue formed in the stationary mold;
forming an S-shaped inlet passage extending in a direction intersecting with a film feeding direction having the first curve and the second curve sequentially in the order from a side of an inlet of a sprue in the movable mold and the stationary mold when the molds are clamped;
passing through the first continuous film on the side of the stationary mold as to render an end thereof face to the first curve of the movable mold; and
passing through the second continuous film on the side of the movable mold as to render an end thereof face to the second curve of the stationary mold
and further comprising the step of:
injecting a resin between the first continuous film and the second continuous film from the S-shaped inlet passage upon clamping the movable mold and the stationary mold to mold a molded product.

6. A method for double-side in-mold transfer molding in using a stationary mold and a movable mold having a cavity for molding a molded product and passing parallel a first continuous film and a second continuous film each having a printing layer facing to one another, the method comprising the steps of:
rendering the stationary mold have a first curve coupled to a sprue formed in the stationary mold;
rendering the movable mold have a second curve coupled to the cavity;
forming an S-shaped inlet passage extending in a direction intersecting with a film feeding direction having the first curve and the second curve sequentially in the order from a side of an inlet of a sprue in the movable mold and the stationary mold when the molds are clamped;
passing through the first continuous film on the side of the stationary mold as to render an end thereof face to the first curve of the movable mold; and
passing through the second continuous film on the side of the movable mold as to render an end thereof face to the second curve of the stationary mold
and further comprising the step of:
injecting a resin between the first continuous film and the second continuous film from the S-shaped inlet passage upon clamping the movable mold and the stationary mold to mold a molded product.

7. A method for double-side in-mold transfer molding in using a stationary mold and a movable mold having a cavity for molding a molded product and passing parallel a first continuous film and a second continuous film each having a printing layer facing to one another, the method comprising the steps of:
forming, in the stationary mold and the movable mold, an S-shaped inlet passage extending in a direction intersecting with a film feeding direction having a first curve and a second curve sequentially in the order from a side of an inlet formed at a mold side surface when the molds are clamped;
passing through the first continuous film on the side of the stationary mold as to render an end thereof face to the second curve; and
passing through the second continuous film on the side of the movable mold as to render an end thereof face to the first curve;
and further comprising the step of:
injecting a resin between the first continuous film and the second continuous film from the S-shaped inlet passage upon clamping the movable mold and the stationary mold to mold a molded product.
